(19) United States
(12) Patent Application Publication
(10) Pub. No.: US 2008/0266720 A1
(43) Pub. Date: Oct. 30, 2008

(54) THIN FILM MAGNETIC HEAD AND METHOD OF MANUFACTURING THE SAME

(76) Inventors: Hisayuki Yazawa, Niigata-ken (JP); Mitsuo Kawasaki, Niigata-ken (JP)

Correspondence Address: BRINKS HOFER GILSON & LIONE, P.O. BOX 10395, CHICAGO, IL, 60610, US

(21) Appl. No.: 11/872,201

(22) Filed: Oct. 15, 2007

(30) Foreign Application Priority Data
Oct. 17, 2006 (JP) 2006-283018

(51) Int. Cl. G11B 5/33

(52) U.S. Cl. 360/314

(57) ABSTRACT

A thin film magnetic head is disclosed having a non-magnetic layer that is formed of a NiPRe (nickel-phosphorus-rhenium) alloy, which makes it possible to optimize the composition ratios of elements Ni, P, and Re, to obtain the non-magnetic layer having a smooth surface, and to prevent concave portions from being formed in both side surfaces of the non-magnetic layer during a milling process, thereby improving recording characteristics.

The composition ratio of a NiPRe alloy forming the non-magnetic layer is set within the range surrounded by boundary lines A to D in a ternary diagram, which makes it possible to form a non-magnetic layer having a smooth surface and uniformly form the magnetic layer on the non-magnetic layer. In addition, since the NiPRe alloy having the composition ratio has a low milling rate, it is possible to prevent concave portions from being formed in both side surfaces of the magnetic layer that is formed on or underneath the non-magnetic layer. As a result, it is possible to accurately regulate a recording track width to a narrow width and thus improve recording characteristics.

### CLAIM FOR PRIORITY

This application claims benefit of the Japanese Patent Application No. 2006-283018 filed on Oct. 17, 2006, which is hereby incorporated by reference.

### BACKGROUND

1. Field of the Invention

The present invention relates to a recording thin film magnetic head, and more particularly, to a thin film magnetic head having a non-magnetic layer that is formed of a NiPRe (nickel-phosphorus-rhenium) alloy and to a method of manufacturing the thin film magnetic head.

2. Description of the Related Art

JP-A-2005-063561 discloses the composition of a NiPRe alloy having characteristics required for a gap layer. JP-A-2005-063562 discloses a thin film magnetic head having a structure in which the width of an upper magnetic layer or a lower magnetic layer in a track width direction is gradually reduced toward a gap layer interposed between the upper magnetic layer and the lower magnetic layer, as viewed from a surface opposite to a recording medium. JP-A-2004-079081 discloses a vertical magnetic recording thin film head including a main magnetic pole portion having a trapezoidal shape in which the width thereof is gradually reduced toward an auxiliary magnetic pole portion.

The NiPRe alloy having a composition ratio disclosed in JP-A-2005-063561 has a high degree of chemical resistance, and it is kept in a non-magnetic state even when it is heated at a high temperature. Therefore, the NiPRe alloy is suitably used as a material forming a gap layer of a thin film magnetic head. However, since the density of Re (rhenium) in the NiPRe alloy is high, the surface of the gap layer is rough after plating. Therefore, it is difficult to control the thickness of the gap layer, and the upper magnetic layer is not uniformly formed on the gap layer.

Since the element Re has a larger weight and a larger atomic weight than an element Ni (nickel) or P (phosphorus), the element Re is etched or milled easier or more rapidly than the element Ni or P during an etching process or a milling process. Therefore, the higher the density of Re becomes, the more rapidly the NiPRe alloy is etched or milled.

In the thin film magnetic head, the lower magnetic layer, the gap layer, and the upper magnetic layer are sequentially formed by plating, and then side milling is performed on the laminated structure to reduce a track width, thereby regulating the track width. In particular, when a gap layer is formed of the NiPRe alloy having the composition ratio disclosed in JP-A-2005-063561, the milling rate of the gap layer is considerably higher than that of the lower magnetic layer or the upper magnetic layer. Therefore, in the milling process, both side surfaces of an upper part of the lower magnetic layer formed underneath the gap layer as well as both side surfaces of the gap layer are largely grinded away, and as shown in FIG. 14, concave portions are formed in both side surfaces of each of the gap layer and the lower magnetic layer, as viewed from a surface opposite to the recording medium.

JP-A-2005-063562 discloses a thin film magnetic head in which the upper magnetic layer and the lower magnetic layer are formed such that the width thereof in the track width direction is gradually reduced toward the gap layer, which makes it possible to prevent the occurrence of side fringing.

When the upper magnetic layer, the gap layer, and the lower magnetic layer that are formed by plating have a large track width (in the range of 0.25 to 0.5 μm), a concave portion is formed in the gap layer, which makes it possible to prevent the side fringing.

However, in recent years, a plating technique or a resist exposing and developing technique has been developed. Therefore, it is possible to form an upper magnetic layer, a gap layer, and a lower magnetic layer having a narrow track width (in the range of 0.1 to 0.25 μm) by plating. However, as shown in FIG. 14, when concave portions are formed in both side surfaces of each of the gap layer and the lower magnetic layer due to the difference between the milling rates and the track width of the upper surface (an interface with the gap layer) of the lower magnetic layer is smaller than the track width of the lower surface (an interface with the gap layer) of the upper magnetic layer, a magnetic field from the upper magnetic layer is not transmitted to the lower magnetic layer well, and thus the waveform of the magnetic field is distorted. As a result, noise is generated, or over-write characteristics or magnetic characteristics deteriorate.

JP-A-2004-079081 discloses a vertical magnetic recording thin film head including a main magnetic pole portion having a trapezoidal shape in which the width thereof is gradually reduced toward an auxiliary magnetic pole portion, which makes it possible to prevent the occurrence of the side fringing.

In the vertical magnetic recording head, when the milling rate of a protective layer that is formed of a non-magnetic material on the main magnetic pole layer is higher than that of the main magnetic pole layer, an upper portion of the main magnetic pole layer contacting with the protective layer is also grinded away by side milling. As a result, as viewed from a surface opposite to a recording medium, concave portions are formed in both side surfaces of the main magnetic pole layer, which has a large effect on a recording track width.

Further, in JP-A-2004-079081, the main magnetic pole layer is formed by plating on a bank layer that is made of a non-magnetic material. However, since the milling rate of the bank layer is higher than the milling rate of the main magnetic pole layer, the bank layer is grinded away by side milling, and then the main magnetic pole layer is inclined, which affects the recording track width or recording characteristics.

As described above, in the vertical magnetic recording thin film head, it is preferable that the milling rate of the non-magnetic layer formed on or underneath the main magnetic pole layer be equal to the milling rate of the main magnetic pole layer.

### SUMMARY

According to an aspect of the invention, a thin film magnetic head includes: a magnetic layer; and a non-magnetic layer that is provided on or underneath the magnetic layer. In the thin film magnetic head, the non-magnetic layer is formed of a NiPRe alloy by plating. In a ternary diagram shown in FIG. 3, the composition ratio of the NiPRe alloy is within the range surrounded by: a straight boundary line A (not including points on the boundary line A) linking a point a (Ni:P:Re) =(84 mass %: 16 mass %: 0 mass %) and a point b (Ni:P:Re)=(72 mass %: 0 mass %: 28 mass %); a straight boundary line B (including points on the boundary line B) linking points where the composition ratio of Re is 2 mass %; a straight boundary line C (including points on the boundary line C) linking points where the composition ratio of Re is 12 mass %; and a straight boundary line D (including points on the boundary line D) linking points where the composition ratio of P is 8 mass %.

The NiPRe alloy having a composition ratio within the above-mentioned range has a high degree of chemical resistance, and thus it can be kept in a non-magnetic state even after a heat treatment is performed.

In the thin film magnetic head according to the above-mentioned aspect, preferably, the non-magnetic layer is a gap layer interposed between an upper magnetic layer and a lower magnetic layer, and at least the lower magnetic layer and the gap layer form a track width regulating portion that regulates a track width Tw in a surface opposite to a recording medium.

In the vertical magnetic recording thin film head, When the main magnetic pole layer and the non-magnetic layer formed on the main magnetic pole layer have the same milling rate, the main magnetic pole layer contacting with the non-magnetic layer is not grinded during a side milling process, and thus concave portions are not formed in both side surfaces of an upper part of the main magnetic pole layer, which does not affect a recording track width. In addition, when the main magnetic pole layer and the non-magnetic layer formed underneath the main magnetic pole layer have the same milling rate, the non-magnetic layer is not grinded during the side milling process, and the main magnetic pole is not inclined.

According to another aspect of the invention, there is provided a method of manufacturing a thin film magnetic head including a magnetic layer and a non-magnetic layer that is provided on or underneath the magnetic layer. The method includes: forming the magnetic layer by plating; plating the magnetic layer with a NiPRe alloy to form the non-magnetic layer on or underneath the magnetic layer; and milling both side surfaces of the magnetic layer in a track width direction to regulate a track width Tw. In the manufacturing method, in a ternary diagram shown in FIG. 3, the composition ratio of the NiPRe alloy is within the range surrounded by: a straight boundary line A (not including points on the boundary line A) linking a point a (Ni:P:Re)=(84 mass %: 16 mass %: 0 mass %) and a point b (Ni:P:Re)=(72 mass %: 0 mass %: 28 mass %); a straight boundary line B (including points on the boundary line B) linking points where the composition ratio of Re is 2 mass %; a straight boundary line C (including points on the boundary line C) linking points where the composition ratio of Re is 12 mass %; and a straight boundary line D (including points on the boundary line D) linking points where the composition ratio of P is 8 mass %.

In the method of manufacturing a thin film magnetic head according to the above-mentioned aspect, preferably, at least a lower magnetic layer and a gap layer, which is the non-magnetic layer, form a track width regulating portion. In the forming of the non-magnetic layer, preferably, the lower magnetic layer is formed by plating and then the gap layer is formed by plating. In the milling of both side surfaces of the magnetic layer, preferably, milling is performed on both side surfaces of each of the gap layer and the lower magnetic layer.

### BRIEF DESCRIPTION OF THE DRAWINGS

FIG. 1 is a front view illustrating a thin film magnetic head according to a first embodiment (as viewed from a surface opposite to a recording medium);

FIG. 2 is a partial cross-sectional view of the thin film magnetic head taken along the line II-II of FIG. 1;

FIG. 3 is a ternary diagram illustrating the composition ratio range of a NiPRe alloy according to the first embodiment of the invention and the relationship between the composition ratio of the NiPRe alloy and a roughness average (Ra);

FIG. 4 is an enlarged view illustrating a lower left portion of the ternary diagram shown in FIG. 3;

FIG. 5 is a partial cross-sectional view illustrating a thin film magnetic head according to a second embodiment;

FIG. 6 is a partial cross-sectional view illustrating a thin film magnetic head according to a third embodiment;

FIG. 7 is a partial cross-sectional view illustrating a thin film magnetic head according to a fourth embodiment;

FIG. 8 is a front view illustrating the thin film magnetic head shown in FIG. 7 (as viewed from a surface opposite to a recording medium);

FIG. 9 is a process diagram illustrating a method of manufacturing the thin film magnetic head shown in FIG. 1 (a partial cross-sectional view illustrating a manufacturing process is shown on the left side of FIG. 9 as viewed from the same cross section as that shown in FIG. 2, and a front view of the manufacturing process is shown on the right side of FIG. 9 as viewed from a surface opposite to a recording medium);

FIG. 10 is a process diagram illustrating a process subsequent to the process shown in FIG. 9 (a partial cross-sectional view illustrating a manufacturing process is shown on the left side of FIG. 10 as viewed from the same cross section as that shown in FIG. 2, and a front view of the manufacturing process is shown on the right side of FIG. 10 as viewed from a surface opposite to a recording medium);

FIG. 11 is a process diagram illustrating a process subsequent to the process shown in FIG. 10 (a partial cross-sectional view illustrating a manufacturing process is shown on the left side of FIG. 11 as viewed from the same cross section as that shown in FIG. 2, and a front view of the manufacturing process is shown on the right side of FIG. 11 as viewed from a surface opposite to a recording medium);

FIG. 12 is a process diagram illustrating a process subsequent to the process shown in FIG. 11 (a front view illustrating the manufacturing process, as viewed from a surface opposite to a recording medium);

FIG. 13 is a diagram schematically illustrating a side milling process that is performed on a laminated structure of a lower magnetic layer, a gap layer that is formed of a NiPRe alloy according to an embodiment of the invention, and an upper magnetic layer, as viewed from a surface opposite to a recording medium;

FIG. 14 is a diagram schematically illustrating a side milling process that is performed on a laminated structure of a lower magnetic layer, a gap layer that is formed of a NiPRe alloy according to the related art, and an upper magnetic layer, as viewed from a surface opposite to a recording medium;

FIG. 15 is a graph illustrating the relationship between the content of an element Re in the NiPRe alloy and a milling rate when milling is performed at a milling angle of 60°;

FIG. 16A is a SIM photograph showing the surface of a solid film that is formed of a NiPRe alloy having a composition ratio according to Example 3 by plating;

FIG. 16B is a SIM photograph enlarging the cross section of a circular portion shown in FIG. 16A;

FIG. 17A is a SIM photograph showing the surface of a solid film that is formed of a NiPRe alloy having a composition ratio according to Comparative example 20 by plating;

FIG. 17B is a SIM photograph enlarging the cross section of a circular portion shown in FIG. 17A;

FIG. 18 is a photograph showing the cross section of a laminated structure of a CoFe layer (lower magnetic layer), a NiPRe alloy layer having a composition ratio according to Example 3 (gap layer), and a CoFe layer (upper magnetic layer) after side milling, as viewed from a surface opposite to a recording medium; and

FIG. 19 is a photograph showing the cross section of a laminated structure of a CoFe layer (lower magnetic layer), a NiPRe alloy layer having a composition ratio according to Comparative example 20 (gap layer), and a CoFe layer (upper magnetic layer) after side milling, as viewed from a surface opposite to a recording medium.

### DESCRIPTION OF THE EMBODIMENTS

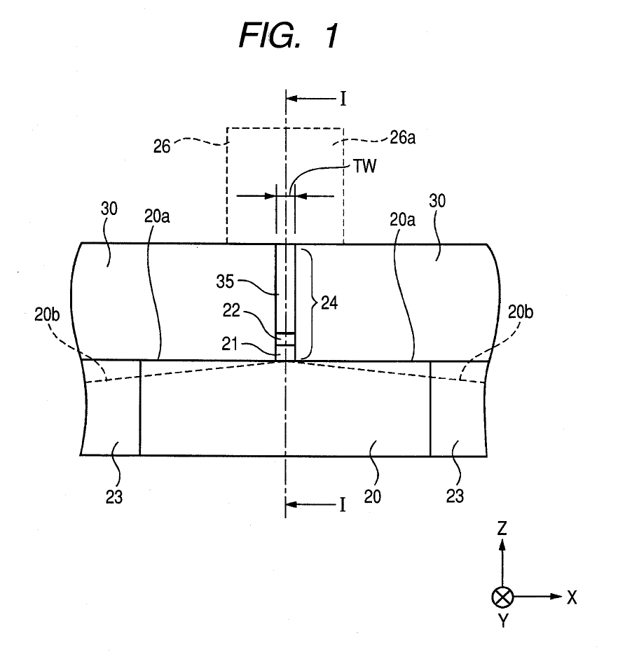

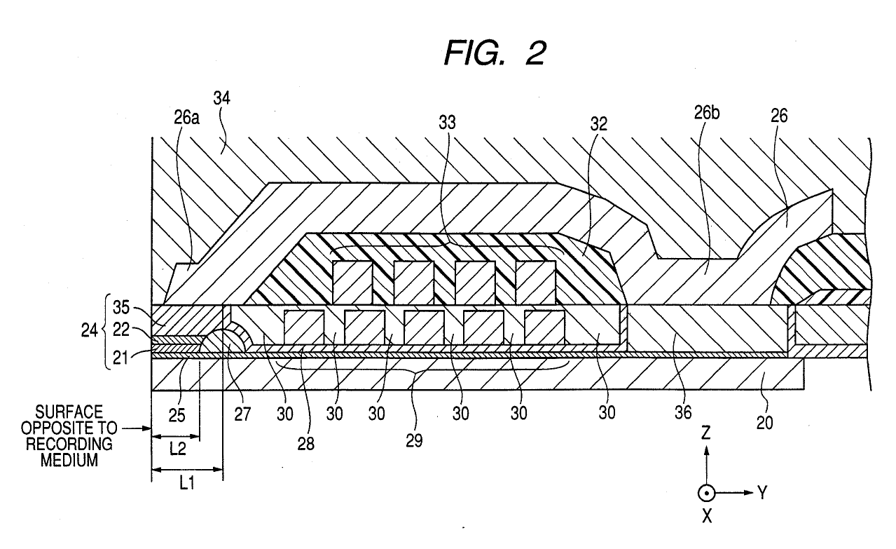

FIG. 1 is a partial front view illustrating the structure of a thin film magnetic head according to an embodiment (as viewed from a surface opposite to a recording medium), and FIG. 2 is a partial cross-sectional view illustrating the thin film magnetic head taken along the line II-II of FIG. 1.

The thin film magnetic head shown in FIG. 1 is a recording inductive head. In this embodiment, a reproducing head using a magnetoresistive effect (a MR head using a magnetoresistive element, such as AMR, GMR, or TMR) may be laminated below the inductive head.

Reference numeral 20 shown in FIG. 1 denotes a lower core layer formed of a magnetic material, such as a NiFe alloy, a CoFe alloy, or a CoFeNi alloy. In addition, when the reproducing head is laminated below the lower core layer 20, a shield layer that protects the magnetoresistive element from noise may be separately provided from the lower core layer 20, or the lower core layer 20 may serve as an upper shield layer of the reproducing head without providing the shield layer.

As shown in FIG. 1, an insulating layer 23 is formed at both sides of the lower core layer 20. As shown in FIG. 1, an upper surface 20a of the lower core layer 20 extending from the base of the lower magnetic layer 21 may be formed so as to extend in parallel to a track width direction (an X direction in FIG. 1), or inclined surfaces 2b may be formed so as to be inclined in a direction that the lower core layer 20 is separated from an upper core layer 26. The inclined surfaces 2b formed at an upper part of the lower core layer 20 make it possible to effectively reduce the occurrence of side fringing.

As shown in FIG. 1, a magnetic pole portion (a track width regulating portion) 24 is formed on the lower core layer 20, and the magnetic pole portion 24 is exposed to a surface opposite to the recording medium. In this embodiment, the magnetic pole portion 24 is formed to have a track width Tw, that is, the magnetic pole portion 24 serves as a track width regulating portion. The track width Tw is preferably set to 0.5 μm or less, more preferably, 0.25 μm or less.

In the embodiment shown in FIG. 1, the magnetic pole portion 24 is formed in a laminated structure of the lower magnetic layer 21, a gap layer 22, and an upper magnetic layer 35.

As shown in FIG. 1, the lower magnetic layer 21, which is the lowest layer of the magnetic pole portion 24a, is formed on the lower core layer 20 with a seed layer 25 (see FIG. 2) interposed therebetween by plating. The lower magnetic layer 21 is magnetically connected to the lower core layer 20, and the lower magnetic layer 21 and the lower core layer 20 may be formed of the same material or different materials. The lower magnetic layer 21 is formed of a magnetic material, such as a NiFe alloy, a CoFe alloy, or a CoFeNi alloy. The lower magnetic layer 21 may be composed of a single-layer film or a multi-layer film. In addition, the seed layer 25 may not be provided.

A non-magnetic gap layer 22 is laminated on the lower magnetic layer 21. The gap layer 22 is formed on the lower magnetic layer 21 by plating.

Next, the upper magnetic layer 35 magnetically connected to an upper core layer 26, which will be described later, is formed on the gap layer 22 by plating. In addition, the upper magnetic layer 35 and the upper core layer 26 may be formed of the same material or different materials. The upper magnetic layer 35 is made of a magnetic material, such as a NiFe alloy, a CoFe alloy, or a CoFeNi alloy. In addition, the upper magnetic layer 35 may be composed of a single-layer film or a multi-layer film.

As shown in FIG. 2, the magnetic pole portion 24 is formed with a length L1 from the surface (ABS surface) opposite to the recording medium in a height direction (a Y direction in FIG. 2). A Gd determining layer 27 formed of, for example, an organic insulating material is formed between the magnetic pole portion 24 and the lower core layer 20. The distance between a leading end of the Gd determining layer 27 to the surface opposite to the recording medium is L2, which is a gap depth (Gd).

As shown in FIG. 2, a first coil layer 29 that is spirally wound is formed on the lower core layer 20, with an insulating base layer 28 interposed therebetween, at the rear side of the magnetic pole portion 24 in the height direction (the Y direction in FIG. 2). The insulating base layer 28 may be formed of an insulating material such as Al₂O₃ or SiO₂.

Further, an insulating layer 30 is filled up spaces among conductors of the coil layer 29. The insulating layer 30 is formed of a combination of an organic insulating material and an inorganic insulating material, such as Al₂O₃, and the insulating layer 30 is formed such that the inorganic insulating material is exposed to the surface opposite to the recording medium.

As shown in FIG. 1, the insulating layer 30 is formed at both sides of the magnetic pole portion 24 in the track width direction (the X direction in FIG. 1) such that the insulating layer 30 is exposed to the surface opposite to the recording medium.

As shown in FIG. 2, a second coil layer 33 that is spirally wound is formed on the insulating layer 30.

As shown in FIG. 2, the second coil layer 33 is covered with an insulating layer 32 that is formed of an organic material, such as a resist or polyimide, and the upper core layer 26 formed of, for example, a NiFe alloy is patterned on the insulating layer 32 by, for example, a frame plating method.

As shown in FIG. 2, a leading end 26a of the upper core layer 26 is formed on the upper magnetic layer 35 so as to be magnetically connected thereto, and a rear end 26b of the upper core layer 26 is formed on a lifting layer 36 that is formed of a magnetic material, such as a NiFe alloy, on the lower core layer 20 so as to be magnetically connected to the lifting layer 36. In other embodiments, the lifting layer 36 may not be formed. In this case, the rear end 26b of the upper core layer 26 is directly connected to the lower core layer 20. The upper core layer 26 is covered with a protective layer 34 formed of for example, Al₂O₃.

In the thin film magnetic head shown in FIGS. 1 and 2, a ‘magnetic circuit unit for applying a recording magnetic field to the magnetic pole portion’ includes the lower core layer 20, the lifting layer 36, and the upper core layer 26.

Next, characteristics of this embodiment of the invention will be described below.

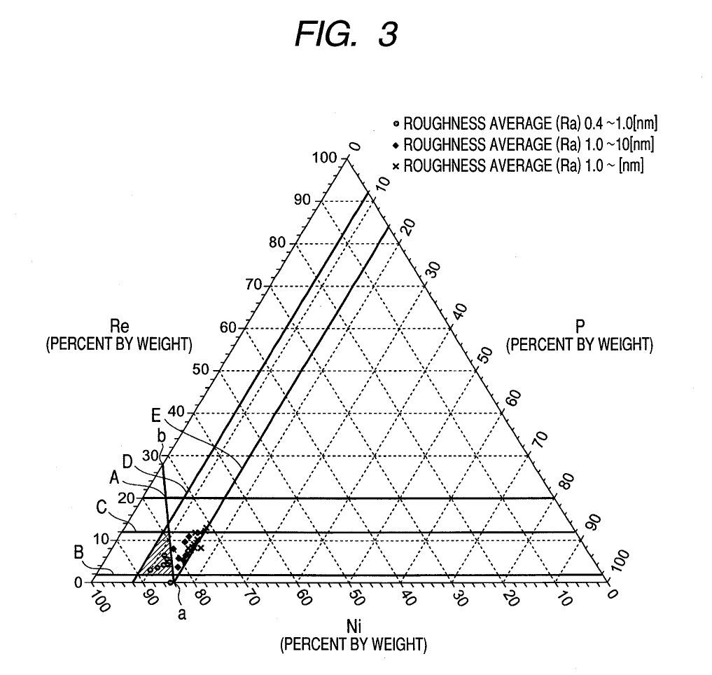

In this embodiment, the gap layer 22 is formed of a NiPRe alloy by plating. The range of the composition ratio of the NiPRe alloy is defined by a ternary diagram shown in FIG. 3. FIG. 4 is a partial enlarged view illustrating a lower left portion of FIG. 3.

In the ternary diagram shown in FIG. 3, the base of a triangle indicates a composition ratio axis of an element Ni, a left side indicates a composition ratio axis of an element Re, and a right side indicates a composition ratio axis of an element P. As shown in FIG. 3, on the composition ratio axes, the composition ratio of the element Ni increases from 0 mass % to 100 mass % in the direction from the right to the left, the composition ratio of the element Re increases 0 mass % to 100 mass % in the ascending direction, and the composition ratio of the element P increases from 0 mass % to 100 mass % in the descending direction.

In this embodiment of the invention, in the ternary diagram shown in FIG. 3, the composition ratio of the NiPRe alloy is within the range surrounded by:
a straight boundary line A (not including points on the boundary line A) linking a point a (Ni:P:Re)=(84 mass %: 16 mass %: 0 mass %) and a point b (Ni:P:Re)=(72 mass %: 0 mass %: 28 mass %);
a straight boundary line B (including points on the boundary line B) linking points where the composition ratio of the element Re is 2 mass %;
a straight boundary line C (including points on the boundary line C) linking points where the composition ratio of the element Re is 12 mass %; and
a straight boundary line D (including points on the boundary line D) linking points where the composition ratio of the element P is 8 mass %.

The composition ratio of the NiPRe alloy can be obtained by setting the ranges of the element P and the element Re, performing plating using the NiPRe alloy within the set composition ratio, and measuring the roughness average (Ra).

In the NiPRe alloy according to this embodiment, the element P and the element Re have a function of accelerating the amorphization of the alloy. The NiRe alloy or a NiP alloy can be easily crystallized, and the NiPRe alloy is easily crystallized by the composition ratios of the element P and the element Re. When alloy is crystallized, chemical resistance to, particularly, alkaline aqueous solution deteriorates, or the alloy is magnetized due to a heat treatment, which is undesirable.

In particular, as the content of the element P in NiPRe alloy increases, the alloy is more likely to be crystallized. Then, the chemical resistance thereof is lowered, and the alloy is easily magnetized due to a heat treatment. When the composition ratio of the element P in the NiPRe alloy is lower than 8 mass %, the alloy is not kept in a non-magnetic state during a high-temperature heat treatment. For this reason, in this embodiment, it is preferable that 8 mass % or more of the element P be contained in the NiPRe alloy.

As the content of the element P in the NiPRe alloy increases, the roughness of the plated surface tends to increase. When the content of the element P is higher than 16 mass %, the roughness average (Ra) of the plated surface is too large to control the thickness of the plated surface. Therefore, it is preferable that the content of the element P in the NiPRe alloy be equal to or lower than 16 mass %.

For the reason stated above, preferably, the content of the element P in the NiPRe alloy is within the range of about 8 mass % to about 16 mass %, that is, within the range between the straight boundary line D (including points on the boundary line D) lining points where the composition ratio of the element P is about 8 mass % and the straight boundary line E (including points on the boundary line E) linking points where the composition ratio of the element P is about 16 mass %.

Next, the composition of the element Re is examined. In the NiPRe alloy, the element P and the element Re have a function of accelerating the amorphization of the alloy, and a small amount of Re is sufficient to accelerate the non-crystalization of the alloy. Therefore, the examination proves that, when the NiPRe alloy contains 2 mass % or more of the element Re, the alloy is kept in a non-magnetic state even after a heat treatment.

The magnetic layer formed by plating needs to have a smooth surface in order to perform exact magnetic recording. However, when the surface of the gap layer surface is rough, the upper magnetic layer is not uniformly formed on the gap layer, which results in a rough upper magnetic layer. Therefore, the gap layer needs to have a smooth surface. Since the element Re has a larger atomic weight than the element Ni or the element P, the larger the content of the element Re becomes, the rougher the surface of the NiPRe alloy becomes after plating. In the NiPRe alloy, when the content of the element Re is higher than about 12 mass %, the roughness average (Ra) after plating is larger than 15 nm. As described above, when the roughness average (Ra) increases, the gap layer requiring a high degree of smoothness becomes rough, which is undesirable. Therefore, it is preferable that the content of the element Re be equal to or lower than about 12 mass %.

Further, since the element Re has a larger atomic weight and a larger weight than the element Ni or the element P, it is more likely to be grinded away by milling. The larger the content of the element Re becomes, the higher the milling rate of the NiPRe alloy becomes. The relationship between the milling rate of the NiPRe alloy, which will be described later, and the content of Re in the NiPRe alloy is examined, and the examination proves that the content of the element Re in the NiPRe alloy is preferably lower than about 12 mass %.

Therefore, it is preferable that the content of the element Re in the NiPRe alloy be in the range of about 2 mass % to about 12 mass %, that is, the composition ratio of the element Re be in the range between the straight boundary line B (including points on the boundary line B) linking points where the composition ratio of the element Re is 2 mass % and the straight boundary line C (including points on the boundary line C) linking points where the composition ratio of the element Re is 12 mass % in FIG. 3.

When both the preferable range of the content of the element P and the preferable range of the content of the element Re are considered, in the NiPRe alloy according to this embodiment of the invention, the content of the element P is in the range of about 8 mass % to about 16 mass %, and the content of the element Re is in the range of about 2 mass % to about 12 mass %. That is, in FIG. 3, preferably, the NiPRe alloy has a composition ratio within a parallelogram surrounded by two pairs of parallel boundary lines B and C, and D and E.

Furthermore, the roughness average (Ra) of the NiPRe alloy having the composition ratio within the parallelogram and in the periphery of the parallelogram after plating is examined in more detail. The roughness average (Ra) of the NiPRe alloy is measured by scanning a plated substrate with a probe at a depth of 50 nm using a contact-type thickness measuring device (Tencor P-10 (manufactured by KLA-Tencor Ltd.)).

The ternary diagram of FIG. 3 shows the results of the experiment, that is, the roughness average (Ra) after plating. A circular plot indicates the composition ratio of the NiPRe alloy having a roughness average (Ra) of 0.4 to 1.0 nm, a diamond-shaped plot indicates the composition ratio of the NiPRe alloy having a roughness average (Ra) of 1.0 to 10 nm, an x plot indicates the composition ratio of the NiPRe alloy having a roughness average (Ra) of 10 nm or more.

In the ternary diagram shown in FIG. 3, the circular plots indicating a small roughness average (Ra) are distributed in a lower left portion, and the diamond-shaped plot and the x plot are distributed in an upper right portion as the roughness average (Ra) increases.

In the ternary diagram shown in FIG. 3, both the composition ratio of the element Re and the composition ratio of the element P are lowered toward the lower left direction. As can be seen from FIG. 3, the lower the composition ratios of the element Re and the element P become, the smaller the roughness average (Ra) becomes after plating.

When the roughness average (Ra) is large, it is difficult to control the thickness of the gap layer that is formed by plating, or it is difficult to uniformly form the upper magnetic layer on the gap layer. When the gap layer is formed of the NiPRe alloy by plating, it is preferable that the roughness average (Ra) be as small as possible.

Here, a straight boundary line A (not including points on the boundary line A) linking a point a (Ni:P:Re)=(84 mass %: 16 mass %: 0 mass %) and a point b (Ni:P:Re)=(72 mass %: 0 mass %: 28 mass %) is provided between the circular plots having a roughness average (Ra) of 0.4 to 1.0 nm and the diamond-shaped plots having a roughness average (Ra) of 1.0 to 10 nm, and a composition ratio region on the left side of the boundary line A in which only the circular plots having a roughness average (Ra) 0.4 to 1.0 nm are included is used as the composition ratio range of the NiPRe alloy according to this embodiment of the invention. In the composition ratio region on the left side of the boundary line A inside the parallelogram, the contents of the element Re and the element P are small.

The composition ratio range of the NiPRe alloy according to this embodiment of the invention is surrounded by the boundary line A (not including points on the boundary line A), and the boundary lines B, C, and D (including points on the boundary lines B, C, and D), and the roughness average (Ra) after plating is in the range of 0.4 to 1.0 nm. As described above, the above-mentioned composition ratio range makes it possible to decrease the roughness average (Ra) and reduce a variation in the roughness average (Ra).

In this embodiment of the invention, the upper magnetic layer 35 can be uniformly formed on the gap layer 22 that is formed of a NiPRe alloy having a small roughness average (Ra). In addition, side milling is performed on both side surfaces of the magnetic pole portion 24 in the track width direction (the X direction in FIG. 1) to reduce the track width Tw. However, in this embodiment of the invention, since the content of the element Re is small (12 mass % or less) and the milling rate of the NiPRe alloy is low, the gap layer formed of the NiPRe alloy and the lower magnetic layer below the gap layer are not excessively grinded away by milling. Therefore, it is possible to form the lower magnetic layer, the gap layer, and the upper magnetic layer in the same shape, as viewed from the surface opposite to the recording medium. As a result, it is possible to appropriately prevent the generation of noise, and thus achieve a thin film magnetic head having a narrow track width and good recording characteristics.

The boundary line B shown in FIG. 3 defines the lowest limit of the content of the element Re to 2 mass %, but according to the results of the examination on the roughness average (Ra), it is preferable that the lowest limit of the content of the element Re be set to 4 mass %. That is, preferably, a boundary line F (FIG. 4) linking points where the composition ratio of the element Re is 4 mass % is used instead of the boundary line B shown in FIG. 3.

Similarly, instead of defining the upper limit of the content of the element Re to 12 mass %, preferably, the boundary line C defines the upper limit of the content of the element Re to 8 mass %. That is, it is preferable that a boundary line G (FIG. 4) linking points where the composition ratio of the element Re is 8 mass % be used instead of the boundary line C shown in FIG. 3.

Therefore, as shown in FIG. 4, in this embodiment of the invention, the composition ratio of the NiPRe alloy is preferably within the range surrounded by the boundary line A (not including points on the boundary line A), the boundary line F, the boundary line C, and the boundary line D (including points on the boundary lines F, C, and D. In addition, the composition ratio of the NiPRe alloy according to this embodiment of the invention is preferably within the range surrounded by the boundary line A (not including the points on the boundary line A), the boundary line B, the boundary line G, and the boundary line D (including points on the boundary lines B, G, and D). Further, the composition ratio of the NiPRe alloy according to this embodiment of the invention is preferably within the range surrounded by the boundary line A (not including the points on the boundary line A), the boundary line F, the boundary line G, and the boundary line D (including the points on the boundary lines F, G, and D) (a hatched region in FIG. 4).

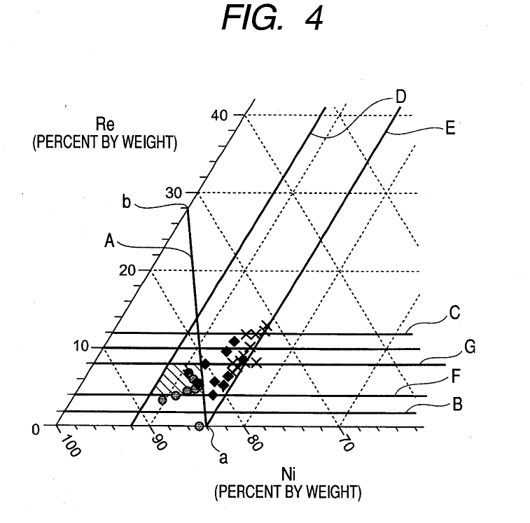

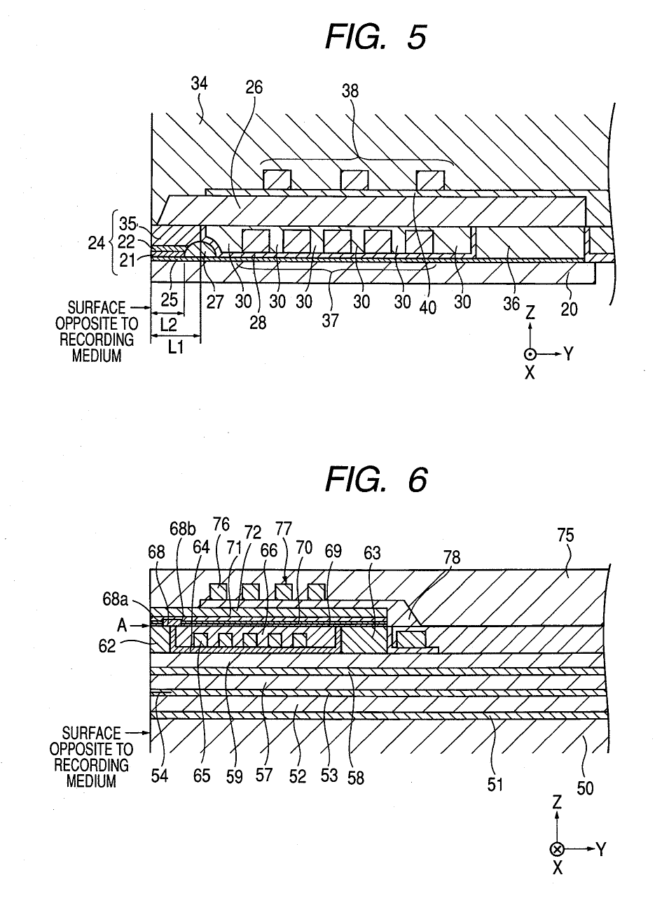

FIG. 5 is a cross-sectional view illustrating a modification of the thin film magnetic head shown in FIG. 2. In FIG. 5, the same layers as those shown in FIG. 2 are denoted by the same reference numerals.

In FIG. 5, a plurality of first coil pieces 37 formed of a conductive material are formed on the insulating base layer 28. The upper surface of an insulating layer 30 covering the first coil pieces 37 is flush with the upper surface of the upper magnetic layer 35, and an upper core layer 26 is formed on the upper magnetic layer 35 and the insulating layer 30.

As shown in FIG. 5, an insulating layer 40 formed of an insulating material, such as a resist, is formed on the upper core layer 26. The insulating layer 40 is preferably formed of an organic insulating material. As shown in FIG. 5, a plurality of second coil pieces 38 formed of a conductive material are formed on the insulating layer 40.

The ends of the first and second coil pieces 37 and 38 in the track width direction are electrically connected to each other, and the first coil piece 37 and the second coil piece 38 form a solenoid-type coil layer.

In the modification shown in FIG. 5, the gap layer 22, the lower magnetic layer 21, and the upper magnetic layer 35 form the magnetic pole portion 24 for regulating the track width Tw in the surface opposite to the recording medium. The gap layer 22 is formed of the NiPRe alloy having the composition ratio within the range shown in FIG. 3 by plating. In this way, the gap layer 22 having a small roughness average (Ra) and a low milling rate is formed.

FIG. 6 is a partial longitudinal cross-sectional view illustrating a thin film magnetic head having a different structure from that shown in FIGS. 1 to 5.

Reference numeral 50 denotes a slider formed of, for example, alumina titanium carbide (Al₂O₃-TiC), and an Al₂O₃ layer 51 is formed on the slider 50.

A lower shield layer 52 formed of, for example, a NiFe-based alloy or sendust, is formed on the Al₂O₃ layer 51, and a gap layer 53 that is formed of, for example, Al₂O₃ and serves as a lower gap layer or an upper gap layer is formed on the lower shield layer 52.

A magnetoresistive element 54, which is a representative example of a GMR element, such as a spin-valve thin film element, is formed in the gap layer 53, and the front surface of the magnetoresistive element 54 is exposed toward the surface opposite to the recording medium.

An upper shield layer 57 is formed of, for example, a NiFe-based alloy on the gap layer 53.

As shown in FIG. 6, a separating layer 58 formed of, for example, Al₂O₃ is formed on the upper shield layer 57. A lower core layer 59 is formed on the separating layer 58.

A protruding layer 62 that protrudes with a predetermined dimension in the height direction (the Y direction in FIG. 6) from the surface opposite to the recording medium is formed on the lower core layer 59. Further, a back gap layer 63 is formed on the lower core layer 59 at a predetermined distance from the protruding layer 62 in the height direction (the Y direction in FIG. 6) of the protruding layer 62.

The protruding layer 62 and the back gap layer 63 are formed of a magnetic material, and each of the protruding layer 62 and the back gap layer 63 may be formed in a single-layer structure or a multi-layer structure.

A coil insulating base layer 64 is formed on the lower core layer 59 between the protruding layer 62 and the back gap layer 63, and a plurality of first coil pieces 65 formed of a conductive material are formed on the coil insulating base layer 64.

The first coil pieces 65 are covered with a coil insulating layer 66 that is formed of an organic insulating material or an inorganic insulating material, such as Al₂O₃. As shown in FIG. 6, the upper surface of the protruding layer 62, the upper surface of the coil insulating layer 66, and the upper surface of the back gap layer 63 are continuously planarized along a reference surface A shown in FIG. 6.

As shown in FIG. 6, a Gd determining layer 68 is formed in the height direction on the planarized surface of the protruding layer 62 and the coil insulating layer 66 at a position that is separated from the surface opposite to the recording medium by a predetermined distance in the height direction (in the Y direction in FIG. 6).

As shown in FIG. 6, a lower magnetic layer 69 and a gap layer 70 are sequentially formed between the surface opposite to the recording medium and a front surface 68a of the Gd determining layer 68 on the protruding layer 62, between a rear end surface 68b of the Gd determining layer 68 and a boundary between the coil insulating layer 66 and the back gap layer 63 in the height direction on the coil insulating layer 66, and on the back gap layer 63. The lower magnetic layer 69 and a gap layer 70 are formed by plating.

As shown in FIG. 6, an upper magnetic layer 71 is formed on the gap layer 70 and the Gd determining layer 68 by plating, and an upper core layer 72 is formed on the upper magnetic layer 71 by plating.

As shown in FIG. 6, an insulating layer 78 formed of an insulating material, such as a resist, is formed on the upper core layer 72. The insulating layer 78 is preferably formed of an organic insulating material.

As shown in FIG. 6, a plurality of second coil pieces 76 made of a conductive material is formed on the insulating layer 78.

The ends of the first and second coil pieces 65 and 76 in the track width direction are electrically connected to each other, and the first coil pieces 65 and the second coil pieces 76 form a solenoid-type coil layer 77.

A protective layer 75 made of an insulating material, such as Al₂O₃ or AlSiO, is formed on the coil layer 77.

In the embodiment shown in FIG. 6, the gap layer 70, the lower magnetic layer 69, and the upper magnetic layer 71 form a track width regulating portion for regulating the track width Tw in the surface opposite to the recording medium, and the gap layer 70 is formed of a NiPRe alloy by plating. The composition ratio of the NiPRe alloy is within the range shown in FIG. 3, which makes it possible to form the gap layer 70 having a small roughness average (Ra) by plating. This structure also makes it possible to form a gap layer having a low milling rate, and thus the gap layer 70 and the lower magnetic layer 69 are not grinded in a subsequent milling process. As a result, unlike the related art, inclined planes are not formed at both sides of an upper part of the lower magnetic layer 69 in the track width direction, and thus the lower magnetic layer 69 and the upper magnetic layer 71 can be formed with substantially the same track width Tw.

The thin film magnetic heads shown in FIGS. 1, 2, 5, and 6 are an ‘in-plane magnetic recording type’ in which recording is performed on the surface of a recording medium in the horizontal direction, but the invention is not limited thereto. The invention may be applied to following vertical-magnetic-recording-type thin film magnetic head.

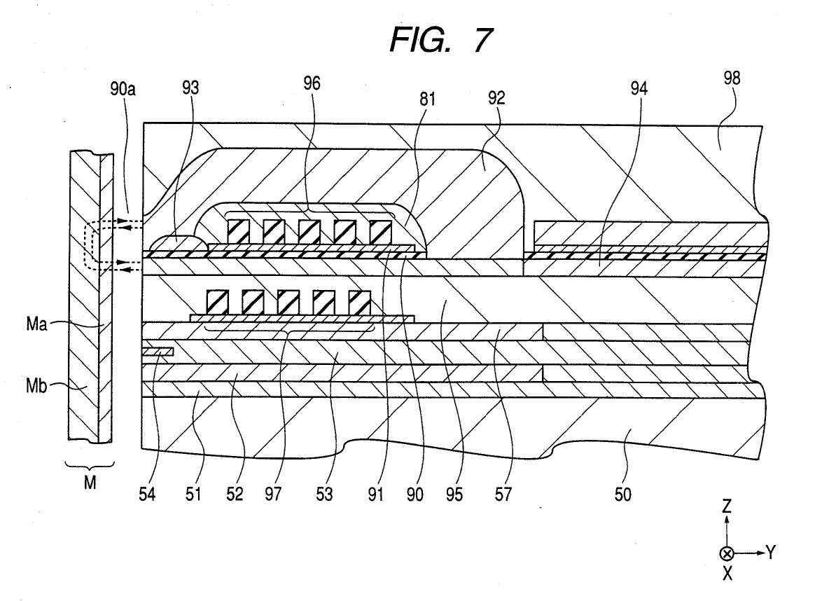

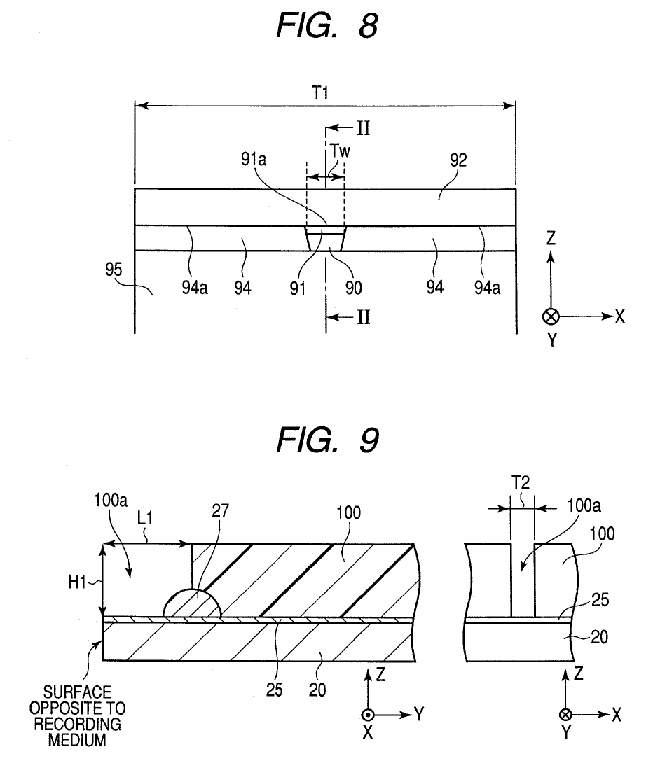

FIG. 7 is a partial longitudinal cross-sectional view illustrating a vertical magnetic recording head that applies a vertical magnetic field to a recording medium M to magnetize a hard film Ma of the recording medium M in the vertical direction (which is a partial longitudinal cross-sectional view taken along the line VIII-VIII of FIG. 8 in the height direction), and FIG. 8 is a partial front view illustrating the vertical magnetic recording head shown in FIG. 7 (as viewed from a surface opposite to the recording medium). In FIG. 8, the same components as those in FIG. 7 are denoted by the same reference numerals.

Further, as shown in FIG. 7, a reproducing head using a magnetoresistive effect (an MR head using a magnetoresistive element, such as AMR, GMR, or TMR) may be formed below the vertical magnetic recording head. As shown in FIG. 7, the reproducing head may be formed in a laminated structure of, for example, a lower shield layer 52, a gap layer 53, a magnetoresistive element 54, and an upper shield layer 57 in this order from the bottom.

In the vertical magnetic recording head, a main magnetic pole layer 90 and a non-magnetic layer 91 are sequentially formed by plating on a non-magnetic insulating layer 95 that is made of an inorganic material, such as Al₂O₃ or SiO₂. A front surface of the main magnetic pole layer 90 is exposed to the surface opposite to the recording medium, and as shown in FIG. 8, the width of the upper surface of the main magnetic pole layer that is exposed to the surface opposite to the recording medium regulates the track width Tw.

As shown in FIG. 8, an insulating layer 94 is formed at both sides of each of the main magnetic pole layer 90 and the non-magnetic layer 91 in the track width direction (the X direction in FIG. 8), and an upper surface 94a of the insulating layer 94 and an upper surface 91 a of the non-magnetic layer 91 are planarized so as to be flush with each other.

As shown in FIG. 7, a slow height layer 93 is formed on the non-magnetic layer 91 at a position that is separated from the surface opposite to the recording medium by a predetermined distance. A coil layer 96 is formed at the rear side of the slow height layer 93, and the coil layer 96 is covered with a coil insulating layer 81.

A return yoke layer 92 is formed on the coil insulating layer 81. A front portion of the return yoke layer 92 is formed on the non-magnetic layer 91 and the insulating layer 94, and is opposite to the main magnetic pole layer 90 with the non-magnetic layer 91 interposed therebetween. In addition, a rear portion of the return yoke layer 92 is magnetically connected to the main magnetic pole layer 90. As shown in FIG. 8, in the surface opposite to the recording medium, the width TI of the return yoke layer 92 in the track width direction is considerably larger than the track width Tw.

In the vertical magnetic recording head shown in FIGS. 7 and 8, a recording magnetic field is induced to the main magnetic pole layer 90 by a magnetic field caused by a current flowing through the coil layer. As shown in FIG. 8, in the surface opposite to the recording medium, the recording magnetic field leaking from the front surface 90a of the main magnetic pole layer 90 sequentially passes through the hard film Ma and the soft film Mb of the recording medium M. The recording magnetic field passing through the soft film Mb is applied to the front surface of the return yoke layer 92 in this embodiment. Since the area of the front surface 90a of the main magnetic pole layer 90 is considerably smaller than that of the front surface of the return yoke layer 92, the leakage recording field is concentrated on the front surface of the main magnetic pole layer 90, and the concentrated magnetic flux magnetizes the hard film Ma in the vertical direction, so that magnetic data is recorded.

As shown in FIG. 7, the main magnetic pole layer 90 is formed on the planarized insulating layer 95. A coil layer 97 is formed inside the insulating layer 95 such that the ends of the coil pieces of the coil layer 97 and the coil layer 96 formed on the main magnetic pole layer 90 are electrically connected to each other in the track width, thereby forming a solenoid-type coil. The coil layer 97 and the coil layer 96 may form a spiral coil shown in FIG. 2, not the solenoid-type coil.

The vertical magnetic recording head having the above-mentioned laminated structure is covered with a protective layer 98 that is formed of, for example, an inorganic non-magnetic insulating material.

In this embodiment, as shown in FIG. 8, the main magnetic pole layer 90 is formed such that the width of the front surface 90a thereof in the track width direction gradually increases upward. When the front surface 90a of the main magnetic pole layer is formed in the shape in which the width thereof gradually increases upward, it is possible to appropriately prevent the occurrence of fringing even when a skew angle is formed. In FIG. 8, the surfaces at both sides of the front surface 90a of the main magnetic pole layer are inclined in sectional view, but they may be formed of curved surfaces. As shown in FIG. 8, the track width Tw is regulated by the width of the upper surface of the main magnetic pole layer 90 in the track width direction.

In the vertical magnetic recording head shown in FIGS. 7 and 8, the non-magnetic layer 91 is formed of the NiPRe alloy having a composition ratio within the range shown in FIG. 3.

When the material forming the non-magnetic layer 91 has a high milling rate, a large amount of non-magnetic layer 91 is grinded away, and the main magnetic pole layer 90 below the non-magnetic layer 91 is also grinded away during a side milling process. As a result, concave portions are formed in both side surfaces of an upper part of the main magnetic pole layer 90, which affects the track width Tw. However, in this embodiment of the invention, the NiPRe alloy having the above-mentioned composition ratio has a low milling rate. Therefore, when the non-magnetic layer 91 is formed of the NiPRe alloy having the above-mentioned composition ratio by plating, it is possible to perform side milling on the non-magnetic layer 91 and the main magnetic pole layer 90 at the same milling rate. Therefore, it is possible to form the main magnetic pole layer 90 in a shape in which the width of the main magnetic pole layer 90 gradually increases upward, without forming concave portions in both side surfaces of the upper part of the main magnetic pole layer 90, as shown in FIG. 8, and thus accurately regulate the track width Tw.

Further, a bank layer (not shown) formed of a non-magnetic material may be formed below the main magnetic pole layer 90. When the bank layer is formed of the NiPRe alloy having the composition ratio according to this embodiment of the invention by plating, it is possible to form a bank layer having a smooth surface since the NiPRe alloy has a small roughness average (Ra), and thus it is possible to form the main magnetic pole layer 90 on the bank layer without unevenness. In addition, the NiPRe alloy having the composition ratio according to this embodiment of the invention has a low milling rate. Therefore, when the bank layer, the main magnetic pole layer 90, and the non-magnetic layer 91 are formed by plating and side milling is performed on these layers, it is possible to prevent the bank layer from being grinded, and thus prevent the main magnetic pole layer 90 and the non-magnetic layer 91 formed on the bank layer from being inclined.

Next, a method of manufacturing the thin film magnetic head shown in FIGS. 1 and 2 will be described with reference to FIGS. 9 to 12. In FIGS. 9 to 11, a partial cross-sectional view illustrating a thin film magnetic head during the same manufacturing process as that shown in FIG. 2 is shown on the left side, and a front view illustrating the thin film magnetic head during the same manufacturing process as that shown in FIG. 1 is shown on the right side. FIG. 12 is a front view illustrating the thin film magnetic head during the same manufacturing process as that shown in FIG. 1, which is subsequent to the process shown in FIG. 11.

In the process shown in FIG. 9, the seed layer 25 is formed on the lower core layer 20 formed of a magnetic material, such as NiFe, by, for example, a sputtering method. It does not matter whether the seed layer 25 is formed of a non-magnetic material or a magnetic material.

Next, the Gd determining layer 27 made of, for example, a resist is formed on the seed layer 25. The Gd determining layer 27 is formed at a position that is separated from the surface opposite to the recording medium backward. For example, a heat treatment is performed on the Gd determining layer 27 to form the surface of the Gd determining layer 27 in a convex shape.

Then, a resist layer (a mask layer) 100 is formed on the Gd determining layer 27 and the entire surface of the seed layer 25, and a resist pattern 100a having a shape corresponding to the magnetic pole portion is formed on the resist layer 100 by exposure and developing processes. The resist pattern 100a is formed in a region from the surface opposite to the recording medium to the Gd determining layer 27. The width T2 of the resist pattern 100a in the track width direction (the X direction in FIG. 9) is set to be slightly larger than the track width Tw of a finished product, in order to appropriately perform plating. In addition, even when the width T2 of the resist pattern 100a is slightly larger than the track width Tw, it is possible to obtain a predetermined track width Tw since side milling is performed to remove the extra seed layer 25 in a subsequent process. Further, in recent years, an exposure technique has been developed, and thus it is possible to accurately process the resist pattern 100a to have a width T2 of about 0.3 μm. Finally, it is possible to perform side milling to reduce the track width Tw to about 0.5 μm or less, preferably, about 0.2 μm or less.

The maximum length L1 of the resist pattern 100a in the height direction (the Y direction in FIG. 9) is set in the range of about 2.5 to about 3.5 μm, and the maximum height Hi of the resist pattern 100a is set in the range of about 1.5 to about 5.0 μm.

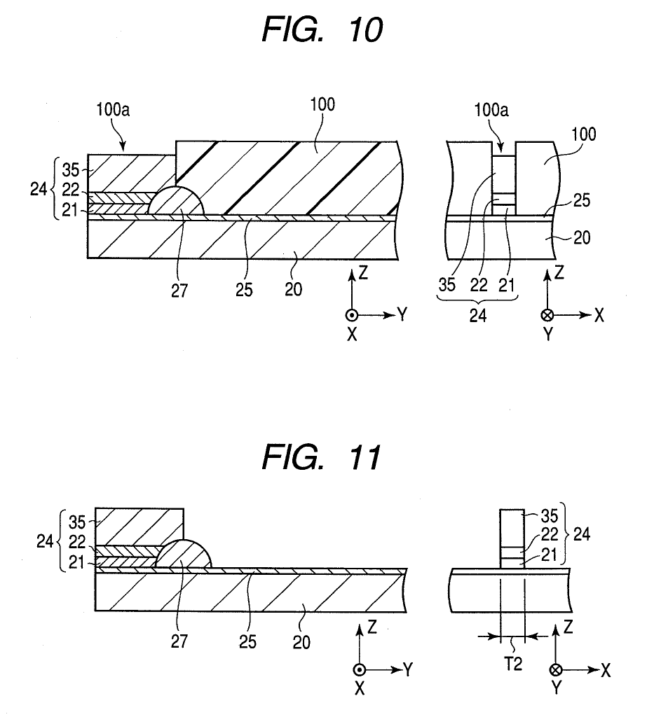

In the next process shown in FIG. 10, the lower magnetic layer 21, the gap layer 22, and the upper magnetic layer 35 are sequentially formed by plating in the resist pattern 100a in this order from the bottom.

The lower magnetic layer 21 is formed on the seed layer 25, by plating, using the seed layer 25 as an electrode. In this embodiment, the lower magnetic layer 21 is formed of a magnetic material, such as NiFe, but it may be formed of a material having higher saturation magnetic flux density (Bs) than the material forming the lower core layer 20. The lower magnetic layer 21 is formed with a thickness of about 0 to about 0.5 μm.

The gap layer 22 is formed on the lower magnetic layer 21 by plating, using the surface of the lower magnetic layer 21 as an electrode.

When the gap layer 22 is formed, in this embodiment of the invention, in the ternary diagram shown in FIG. 3, the composition ratio of a NiPRe alloy is adjusted within the range surrounded by:
a straight boundary line A (not including points on the boundary line A) linking a point a (Ni:P:Re)=(84 mass %: 16 mass %: 0 mass %) and a point b (Ni:P:Re)=(72 mass %: 0 mass %: 28 mass %);
a straight boundary line B (including points on the boundary line B) linking points where the composition ratio of an element Re is 2 mass %;
a straight boundary line C (including points on the boundary line C) linking points where the composition ratio of the element Re is 12 mass %; and
a straight boundary line D (including points on the boundary line D) linking points where the composition ratio of an element P is 8 mass %.

In this way, it is possible to set the roughness average (Ra) of the surface of the gap layer 22 within the range 0.4 to 1.0 nm, which makes it easy to form the gap layer 22 with a uniform thickness.

The gap layer 22 is formed with a thickness of about 0.05 to about 0.15 μm.

The upper magnetic layer 35 is formed on the gap layer 22 by plating, using the surface of the gap layer 22 as an electrode. However, in this case, since the surface of the gap layer 22 has a low degree of roughness and a high degree of smoothness, the upper magnetic layer 35 can be uniformly and closely formed on the gap layer 22.

The upper magnetic layer 35 is preferably formed of a magnetic material, such as NiFe, which has higher saturation magnetic flux density (Bs) than the material forming the upper core layer 26 that will be formed in a subsequent process. The upper magnetic layer 35 is formed with a thickness of about 1.5 to 3.4 μm.

Next, in the process shown in FIG. 11, the resist layer 100 is removed. Then, an elongated magnetic pole portion 24 having the width T2 in the track width direction (the X direction in FIG. 11) remains on the seed layer 25 that is formed on the entire surface of the lower core layer 20.

Then, in the process shown in FIG. 12, side milling is performed on the surfaces 24a at both sides of the magnetic pole portion 24 in the track width direction (the X direction in FIG. 12) using inert gas, such as Ar.

In the side milling process, portions of the seed layer 25 represented by dotted lines in FIG. 12 are removed, and only a portion of the seed layer 25 corresponding to the magnetic pole portion 24 remains.

As shown in FIG. 12, a milling angle θ is defined as an interior cross angle between the track width direction (the X direction) and the milling direction.

In this embodiment of the invention, the milling angle θ is set in the range of about 20 to about 60°, preferably, about 60°.

In this embodiment of the invention, when the composition ratio of the gap layer 22 is adjusted within the above-mentioned range and the milling angle θ is set in the range of about 20 to about 60°, a milling rate of both side surfaces of the gap layer 22 can be set in the range of about 4 to about 8 nm/min. Since the milling rate of both side surfaces of the lower magnetic layer 21 or the upper magnetic layer 35 is set to about 4 nm/min, the milling rate of both side surfaces of the gap layer 22 can be approximate to the milling rate of both side surface of the lower magnetic layer 21 or the upper magnetic layer 35.

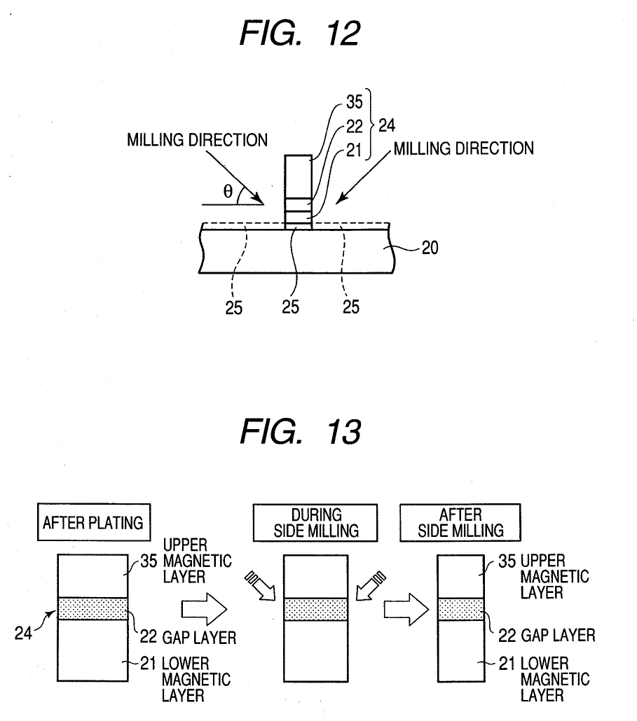

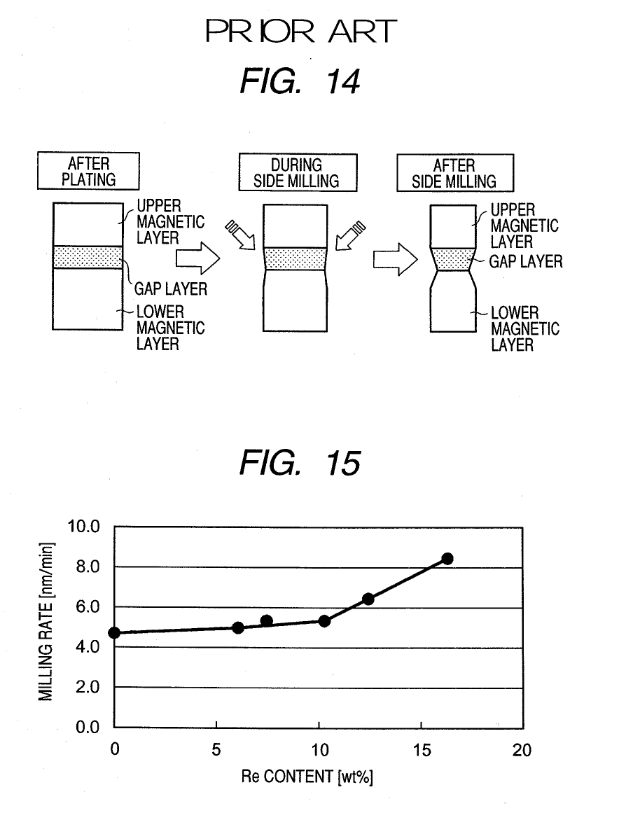

FIG. 13 is a diagram schematically illustrating the magnetic pole portion according to this embodiment of the invention. Both side surfaces of each of the lower magnetic layer 21, the gap layer 22, and the upper magnetic layer 35 can be uniformly grinded by side milling, and after the side milling, it is easy to form both side surfaces of each of the lower magnetic layer 21, the gap layer 22, and the upper magnetic layer 35 in a straight shape parallel to the height direction. Therefore, unlike the related art shown in FIG. 14, it is possible to prevent the gap layer and the lower magnetic layer from being sequentially grinded and thus concave portions from being formed in both side surfaces of the gap layer and the lower magnetic layer.

In this embodiment of the invention, the milling process regulates the width of the magnetic pole portion 24 in the track width direction (the X direction in FIG. 13) to a predetermined track width Tw. In this case, unlike the related art, the width of the upper surface of the lower magnetic layer 21 at an interface between the gap layer 22 and the lower magnetic layer 21 is substantially equal to the width of the lower surface of the upper magnetic layer 35 at an interface between the gap layer 22 and the upper magnetic layer 35. Therefore, it is possible to narrow the track width and prevent the generation of noise, which makes it possible to appropriately manufacture a thin film magnetic head having good recording characteristics easily.

After the milling process shown in FIG. 12, the insulating base layer 28, the first coil layer 29, and the insulating layer 30 shown in FIG. 2 are sequentially formed, and the upper surface of the magnetic pole portion 24 and the upper surface of the insulating layer 30 are planarized by a CMP technique. Then, the second coil layer 33, the coil insulating layer 32, the upper core layer 26, and the protective layer 34 are sequentially formed on the planarized surface.

The vertical magnetic recording head shown in FIGS. 7 and 8 are also manufactured by the manufacturing method shown in FIGS. 9 to 12.

That is, a seed layer (not shown) is formed on the insulating layer 95 by a sputtering method, and a resist layer having a resist pattern corresponding to the shapes of the main magnetic pole layer 90 and the non-magnetic layer 91 is formed on the seed layer. As viewed from the surface opposite to a recording medium, the resist pattern has a shape in which the width thereof in the track width direction gradually increases upward. The width of the surface of the resist pattern in the track width direction is slightly larger than the track width of a finished product in consideration of a chipping allowance during side milling.

Then, the main magnetic pole layer 90 and the non-magnetic layer 91 are formed in the resist pattern by plating, and the resist is removed. Alternatively, a bank layer may be formed, and then the main magnetic pole layer 90 and the non-magnetic layer 91 may be formed. Then, both side surfaces of each of the main magnetic pole layer 90 and the non-magnetic layer 91 in the vicinity of the surface opposite to the recording medium are grinded away by ion milling, thereby obtaining the main magnetic pole layer 90 and the non-magnetic layer 91 having the shapes shown in FIG. 8. In this case, the width of the upper surface of the main magnetic pole layer 90 in the track width direction regulates the track width Tw. Then, the protective layer 98 is formed.

In the thin film magnetic head shown in FIGS. 7 and 8, a yoke layer may be formed at the rear side of the main magnetic pole layer 90, or the return yoke layer 92 may be formed below the main magnetic pole layer 90.

### EXAMPLES

In this embodiment of the invention, the following experiment is conducted, and the results of the experiment are shown in the ternary diagram of FIG. 3, which defines the preferable range of the composition ratio of a NiPRe alloy.

First, the relationship between the content of an element Re in the NiPRe alloy and a milling rate after plating is examined to calculate the preferable range of the content of the element Re.

In the experiment, solid films are formed of NiPRe alloys having composition ratios a to f shown in Table 1 by plating. The milling rates thereof are measured by using an inclination angle with respect to the thickness direction of the solid film (the vertical direction of the surface of the solid film) as a milling angle θ and setting the milling angle θ to 60°. The measured results for the composition ratios are shown in Table 1. In the experiment, a resist pattern is formed on the solid film that is formed by plating, milling is performed thereon for 60 minutes using a milling machine, and the resist is removed. The height difference between a portion covered with the resist and the other portion not covered with the resist is measured by a contact-type thickness measuring device (Tencor P-10), and the height difference per unit time (minute) is calculated, thereby obtaining a milling rate (nm/min).

TABLE 1

| | Content of Re | Content of Ni | Content of P | Milling rate |
|---|---|---|---|---|
| | (mass %) | (mass %) | (mass %) | (nm/min) |
| a | 16.3 | 70.6 | 13.1 | 8.4 |
| b | 12.5 | 74.6 | 12.9 | 6.4 |
| c | 10.3 | 76.8 | 12.9 | 5.4 |
| d | 7.5 | 79.6 | 13.0 | 5.3 |
| e | 6.1 | 81.0 | 13.0 | 5.0 |
| f | 0.0 | 84.8 | 15.3 | 4.8 |

FIG. 15 shows the relationship between the content of an element Re in the NiPRe alloy and the milling rate represented in Table 1. When the content of the element Re in the NiPRe alloy is in the range of 0 to 10 mass %, there is little variation in the milling rate. However, when the content of the element Re in the NiPRe alloy is higher than 10 mass %, the milling rate increases suddenly. Therefore, the content of the element Re in the NiPRe alloy is preferably equal to or lower than 12 mass %, more preferably, 10 mass %.

Further, solid films are formed of the NiPRe alloys having the composition ratios shown in Table 2 by plating, and the roughness average (Ra) of the surface of each of the solid films is measured. The measured roughness averages (Ra) and the composition ratios are shown in Table 2. As described above, the roughness average (Ra) of each of the solid films is measured by scanning a plated substrate with a probe at a depth of 50 nm using a contact-type thickness measuring device (Tencor P-10 (manufactured by KLA-Tencor Ltd.)).

TABLE 2

| | P | Re | Ni | Roughness average | Plot in |
|---|---|---|---|---|---|
| | (mass %) | (mass %) | (mass %) | (Ra) (nm) | FIG. 3 |
| Example 1 | 10.6 | 4.3 | 85.1 | 0.468 | |
| Example 2 | 12.39 | 5.26 | 82.35 | 0.470 | |
| Example 3 | 12.71 | 5.52 | 81.77 | 0.480 | |
| Example 4 | 11.5 | 6.2 | 82.3 | 0.485 | |
| Example 5 | 10.5 | 7.3 | 82.2 | 0.495 | |
| Example 6 | 9.48 | 3.67 | 86.85 | 0.680 | |
| Example 7 | 11.48 | 4.84 | 83.68 | 0.790 | |
| Example 8 | 12.23 | 5.1 | 82.67 | 0.830 | |
| Example 9 | 12.34 | 5.71 | 81.96 | 0.880 | |
| Reference example 1 | 15.25 | 0 | 84.75 | 0.650 | |
| Comparative example 1 | 13.6 | 6.52 | 79.88 | 1.150 | ♦ |
| Comparative example 2 | 14.66 | 7.13 | 78.21 | 1.180 | ♦ |
| Comparative example 3 | 12.91 | 10.29 | 76.8 | 1.250 | ♦ |
| Comparative example 4 | 11.59 | 8.57 | 79.84 | 1.260 | ♦ |
| Comparative example 5 | 14.53 | 4.43 | 81.04 | 1.470 | ♦ |
| Comparative example 6 | 13 | 11.57 | 75.43 | 2.205 | ♦ |
| Comparative example 7 | 14.96 | 5.93 | 79.11 | 2.540 | ♦ |
| Comparative example 8 | 14.5 | 11.6 | 73.9 | 10.000 | × |
| Comparative example 9 | 15.65 | 8.41 | 75.94 | 10.455 | × |
| Comparative example 10 | 15.48 | 7.58 | 76.94 | 10.465 | × |
| Comparative example 11 | 15.06 | 7.62 | 77.32 | 11.265 | × |
| Comparative example 12 | 16.13 | 3.8 | 80.08 | 12.550 | × |
| Comparative example 13 | 15.5 | 11.5 | 73 | 15.000 | × |
| Comparative example 14 | 15.75 | 12.77 | 71.48 | 15.970 | × |
| Comparative example 15 | 15.54 | 9.99 | 74.47 | 19.240 | × |
| Comparative example 16 | 15.46 | 6.88 | 77.66 | 30.580 | × |
| Comparative example 17 | 14.94 | 8.37 | 76.69 | 33.415 | × |
| Comparative example 18 | 16.96 | 8.05 | 74.99 | 37.275 | × |
| Comparative example 19 | 15.08 | 8.52 | 76.4 | 39.115 | × |
| Comparative example 20 | 16 | 12 | 72 | 40.000 | × |
| Comparative example 21 | 15.5 | 8.64 | 75.86 | 45.055 | × |
| Comparative example 22 | 15.64 | 8.25 | 76.11 | 45.855 | × |
| Comparative example 23 | 15.77 | 7.99 | 76.24 | 47.335 | × |

The measured roughness averages (Ra) are classified into three ranges, that is, a first range of 0.4 to 1.0 nm (circular plot), a second range of 1.0 to 10 nm (diamond-shaped plot), and a third range of 10 nm or more (X plot), and the corresponding composition ratios of the NiPRe alloys are shown in the ternary diagram of FIG. 3.

As can be seen from FIG. 3, the lower the composition ratio of the element Re or the element Po becomes, the smaller the roughness average (Ra) becomes. The NiPRe alloy having a composition ratio within the range surrounded by the boundary lines A to D has a small roughness average (Ra) of 0.4 to 1.0 nm, and thus is most suitable for a material forming the gap layer. In the range surrounded by the boundary line A to D, a variation in the roughness average (Ra) is smaller than that in the other ranges. The NiPRe alloy having the composition ratio according to Reference example 1 shown in Table 2 has a small roughness average (Ra) of 0.65 nm, but the content of Re is 0 mass %. Therefore, a NIP alloy having the composition ratio according to Reference example 1 is difficult to maintain a non-magnetic state after heat treatment.

FIG. 16A is a photogram showing the surface of a solid film that is formed of a NiPRe alloy having the composition ratio according to Example 3 by plating (a photograph captured by a SIM). FIG. 16B is an enlarged photograph showing the cross section of a circular portion shown in FIG. 16A taken along the thickness direction. As can be seen from FIGS. 16A and 16B, there is no unevenness in the surface, and the surface is very smooth. In this case, the roughness average (Ra) of the plated surface is equal to or smaller than 0.8 nm.

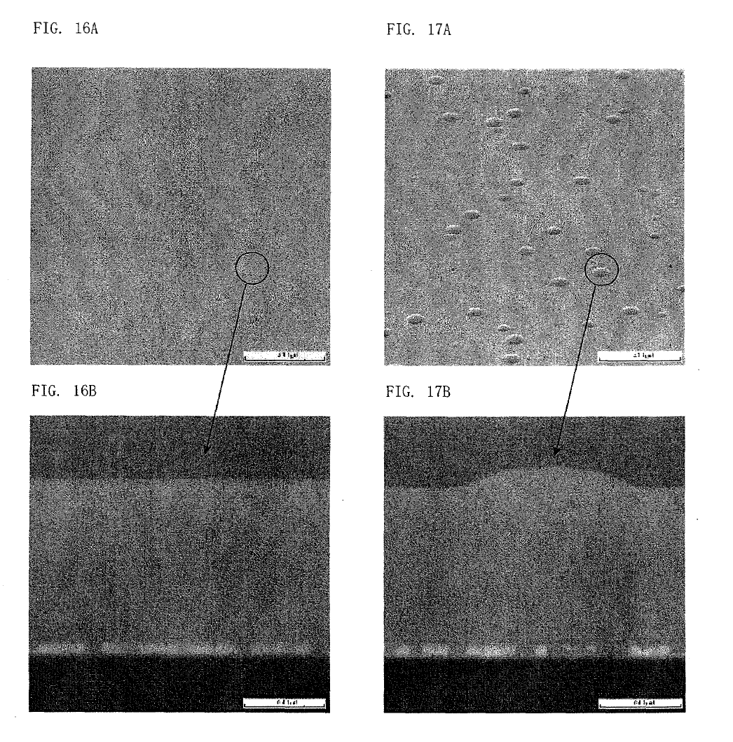

Similarly, FIG. 17A is a photograph showing the surface of a solid film that is formed of a NiPRe alloy having the composition ratio according to Comparative example 20 by plating, and FIG. 17B is an enlarged photograph showing the cross sectional of a circular portion shown in FIG. 17A taken along the thickness direction. As can be seen from FIGS. 17A and 17B, there are many domical protrusions on the plated surface. In this case, the roughness average (Ra) of the plated surface is 40 nm.

Next, a lower magnetic layer is formed of CoFe inside the resist pattern of the resist layer, and gap layers formed of NiPRe alloys having the composition ratios according to Example 3 and Comparative example 20, respectively, are formed on the low magnetic layer. Then, an upper magnetic layer formed of CoFe is formed on the gap layer by plating, thereby obtaining a laminated structure.

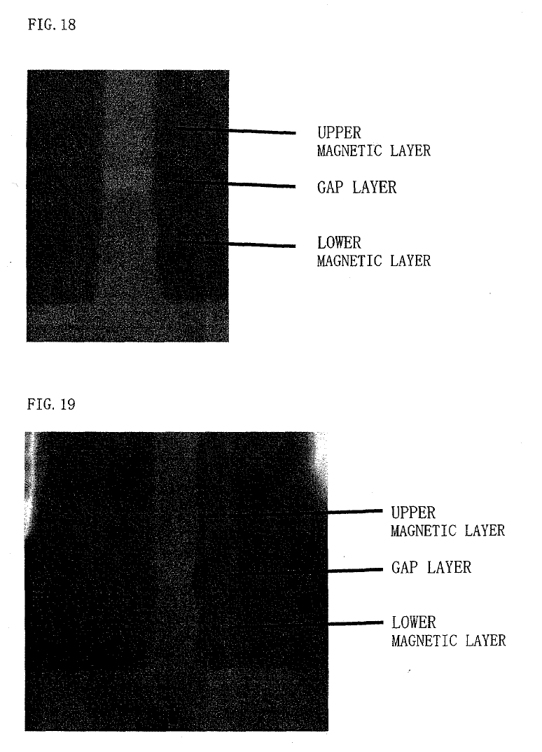

Subsequently, side milling is performed on the obtained laminated structure at a milling angle θ (see FIG. 12) of 60°. FIGS. 18 and 19 show the films after side milling. FIG. 18 shows the shape of the laminated structure after side milling is performed on the gap layer that is formed of a NiPRe alloy having the composition ratio according to Example 3 (a photograph captured by a SIM (scanning ion microscope)), and FIG. 19 shows the shape of the laminated structure after side milling is performed on the gap layer that is formed of a NiPRe alloy having the composition ratio according to Comparative example 20 (a photograph captured by a SIM (scanning ion microscope)).

As can be seen from FIG. 18, both side surfaces of the gap layer formed of the NiPRe alloy having the composition ratio according to Example 3 and both side surfaces of each of the lower magnetic layer and the upper magnetic layer are grinded in substantially straight shapes by side milling, so that the lower magnetic layer, the gap layer, and the upper magnetic layer have substantially the same width in the track width direction. Therefore, both side surfaces of a magnetic layer including the lower magnetic layer, the gap layer, and the upper magnetic layer in the track width direction extend a substantially straight shape in the thickness direction.

On the other hand, as can be seen from FIG. 19, both side surfaces of the gap layer that is formed of the NiPRe alloy having the composition ratio according to Comparative example 20 are largely grinded away by side milling. In particular, a larger amount of gap layer is grinded away to the bottom, and a portion of the lower magnetic layer underneath the gap layer is also grinded away. As a result, large concave portions are formed in both side surfaces of the laminated structure in the range extending from the gap layer to an upper part of the lower magnetic layer, which makes the width of the upper surface (an interface with the gap layer) of the lower magnetic layer in the track width direction smaller than the width of the lower surface (an interface with the gap layer) of the upper magnetic layer in the track width direction.

As described above, the NiPRe alloy having the composition ratio according to this embodiment of the invention makes it possible to reduce the milling rate. As a result, the milling rates of the lower magnetic layer and the upper magnetic layer are approximate to each other. Therefore, unlike the related art, it is possible to prevent large concave portions from being formed in both side surfaces of each of the gap layer and the lower magnetic layer, and thus to form the lower magnetic layer, the gap layer, and the upper magnetic layer to have substantially the same track width.

1. A thin film magnetic head comprising:
a magnetic layer; and
a non-magnetic layer that is provided on or underneath the magnetic layer, wherein the non-magnetic layer is formed of a NiPRe alloy by plating, and in a ternary diagram shown in FIG. 3, the composition ratio of the NiPRe alloy is within the range surrounded by:
a straight boundary line A (not including points on the boundary line A) linking a point a (Ni:P:Re)=(84 mass %: 16 mass %: 0 mass %) and a point b (Ni:P:Re)=(72 mass %: 0 mass %: 28 mass %);
a straight boundary line B (including points on the boundary line B) linking points where the composition ratio of Re is 2 mass %;
a straight boundary line C (including points on the boundary line C) linking points where the composition ratio of Re is 12 mass %; and
a straight boundary line D (including points on the boundary line D) linking points where the composition ratio of P is 8 mass %.

2. The thin film magnetic head according to claim 1,
wherein the non-magnetic layer is a gap layer interposed between an upper magnetic layer and a lower magnetic layer, and
at least the lower magnetic layer and the gap layer form a track width regulating portion that regulates a track width Tw in a surface opposite to a recording medium.

3. The thin film magnetic head according to claim 1,
wherein the thin film magnetic head is a vertical magnetic recording type including a main magnetic pole layer, and
the magnetic layer is the main magnetic pole layer.

4. A method of manufacturing a thin film magnetic head including a magnetic layer and a non-magnetic layer that is provided on or underneath the magnetic layer, comprising:
forming the magnetic layer by plating;
plating the magnetic layer with a NiPRe alloy to form the non-magnetic layer on or underneath the magnetic layer; and
milling both side surfaces of the magnetic layer in a track width direction to regulate a track width Tw,
wherein, in a ternary diagram shown in FIG. 3, the composition ratio of the NiPRe alloy is within the range surrounded by:
a straight boundary line A (not including points on the boundary line A) linking a point a (Ni:P:Re)=(84 mass %: 16 mass %: 0 mass %) and a point b (Ni:P:Re)=(72 mass %: 0 mass %: 28 mass %);
a straight boundary line B (including points on the boundary line B) linking points where the composition ratio of Re is 2 mass %;
a straight boundary line C (including points on the boundary line C) linking points where the composition ratio of Re is 12 mass %; and
a straight boundary line D (including points on the boundary line D) linking points where the composition ratio of P is 8 mass %.

5. The method of manufacturing a thin film magnetic head according to claim 4,
wherein at least a lower magnetic layer and a gap layer, which is the non-magnetic layer, form a track width regulating portion,
in the forming of the non-magnetic layer, the lower magnetic layer is formed by plating and then the gap layer is formed by plating, and
in the milling of both side surfaces of the magnetic layer, milling is performed on both side surfaces of each of the gap layer and the lower magnetic layer.
